(19) United States
(12) Patent Application Publication
(10) Pub. No.: US 2010/0203426 A1
(43) Pub. Date: Aug. 12, 2010

(54) FUEL CELL

(75) Inventors: Chi-Yang Chiu, Taoyuan County (TW); Ming-Chou Tsai, Taoyuan County (TW); Ching-Sen Yang, Taoyuan County (TW); Chiang-Wen Lai, Taoyuan County (TW); Wei-Kai Chang, Taoyuan County (TW)

Correspondence Address: QUINTERO LAW OFFICE, PC, 615 Hampton Dr, Suite A202, Venice, CA, 90291, US

(73) Assignee: NAN YA PCB CORP., Taoyuan County (TW)

(21) Appl. No.: 12/408,969

(22) Filed: Mar. 23, 2009

(30) Foreign Application Priority Data
Feb. 12, 2009 (TW) TW098104427

(51) Int. Cl. H01M 2/02

(52) U.S. Cl. 429/517

(57) ABSTRACT

A fuel cell is provided, including an integrated cathode/anode flow board, a first anode current collector, a first cathode current collector, a first membrane electrode assembly, a second anode current collector, a second cathode current collector, and a second membrane electrode assembly. The integrated cathode/anode flow board includes first cathode channels for air to flow through, and a plurality of first anode channels for a fuel to flow through. The first cathode channels and the first anode channels are disposed on opposite sides of the integrated cathode/anode flow board. The first anode current collector contacts the first anode channels. The first membrane electrode assembly is sandwiched between the first anode current collector and the first cathode current collector. The second anode current collector contacts the first cathode channels. The second membrane electrode assembly is sandwiched between the second anode current collector and the second cathode current collector.

### CROSS REFERENCE TO RELATED APPLICATIONS

This Application claims priority of Taiwan Patent Application No. 98104427, filed on Feb. 12, 2009, the entirety of which is incorporated by reference herein.

### BACKGROUND OF THE INVENTION

1. Field of the Invention

The present invention relates to a fuel cell, and in particular relates to a fuel cell with improved dissipation efficiency.

2. Description of the Related Art

FIG. 1 is a cross section of a conventional fuel cell module 10. The conventional fuel cell module 10 includes a cathode current collector 11, a membrane electrode assembly (MEA) 12, an anode current collector 13 and an anode channel board 14 which are all stacked.

The anode channel board 14 includes a plurality of parallel ribs 141, and a plurality of channels 143 formed between the ribs 141 is provided for a fuel 31 to flow therethrough.

Two membrane electrode assemblies 12 are disposed on two sides of the anode channel board 14. The cathode current collector 11 is abutted against one side of the membrane electrode assembly 12, and the anode current collector 13 is abutted against the other side of the membrane electrode assembly 12. The anode current collector 13 is also abutted against the anode channel board 14.

The membrane electrode assembly 12 is a nuclear component of the fuel cell utilized to convert chemical energy to electricity. Electrons generated from an anode terminal of the fuel cell are transmitted to an external lead wire via the anode current collector 13 for loading, and then the electrons are recovered while being transmitted to the cathode via the cathode current collector 11.

In the operation of the fuel cell module 10, the air 32 outwardly passing through the cathode current collector 11 dissipates heat generated from the fuel cell module 10. Due to the anode terminal, located at the middle of the fuel cell module 10 (located nearby the anode channel board 14 and the anode current collector 13), being distant from the air 32, heat dissipation for the anode terminal is inefficient.

To lighten the fuel cell module 10, a polymer composite material is generally applied. However, after long-term operation, the cathode current collector 11 usually ends up protruding outwardly. Thus, increasing impedance and decreasing performance of the fuel cell module 10.

### BRIEF SUMMARY OF THE INVENTION

To overcome the described problems of the conventional fuel cell module, the structural design of the fuel cell must be improved.

A fuel cell of the invention comprises an integrated cathode/anode flow board, a first anode current collector, a first cathode current collector, a first membrane electrode assembly, a second cathode current collector, a second cathode current collector, a second anode current collector and a second membrane electrode assembly. The integrated cathode/anode flow board comprises a plurality of first cathode channels for air to flow therethrough and a plurality of first anode channels for a fuel to flow therethrough. The first cathode channels and the first anode channels are disposed on opposite sides of the integrated cathode/anode flow board. The first anode current collector contacts with the first anode channels. The first membrane electrode assembly is sandwiched between the first anode current collector and the first cathode current collector. The second cathode current collector contacts with the first cathode channels. The second membrane electrode assembly is sandwiched between the second anode current collector and the second cathode current collector.

In one embodiment, the fuel cell further comprises a cathode pressing board abutted against the first cathode current collector.

In one embodiment, the cathode pressing board comprises second cathode channels contacted with the first cathode current collector for the air to flow therethrough.

In one embodiment, the fuel cell further comprises an anode pressing board abutted against the second anode current collector.

In one embodiment, the anode pressing board comprises second anode channels contacted with the second anode current collector for the fuel to flow therethrough.

During operation of the fuel cell module, because the air passes through the plurality of second cathode channels of the integrated cathode/anode flow board located at the middle of the fuel cell module, efficient heat dissipation is achieved (with the air merely flowing through the outside thereof).

Additionally, due to the cathode pressing board and the anode pressing board being disposed outside of the fuel cell module, the cathode pressing board and the anode pressing board can effectively suppress and prevent the first cathode current collector and the second anode current collector from protruding outwardly after long-term operation, thus, preventing increased impedance and decreased performance of the fuel cell module.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross section of a conventional fuel cell module;

FIG. 2 is a cross section of a first embodiment of a fuel cell of the invention;

FIG. 3A shows the condition of an anode surface of an integrated cathode/anode flow board of FIG. 2;

FIG. 3B shows the condition of a cathode surface of an integrated cathode/anode flow board of FIG. 2; and

FIG. 4 is a cross section of a second embodiment of a fuel cell of the invention.

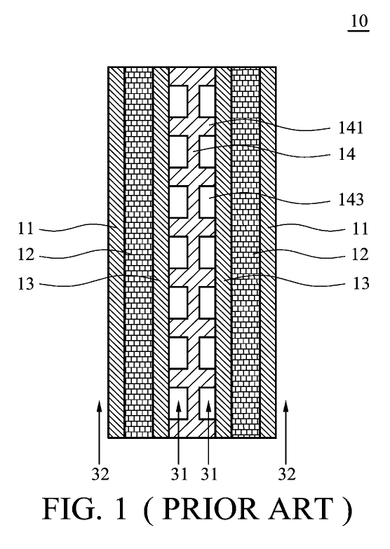

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

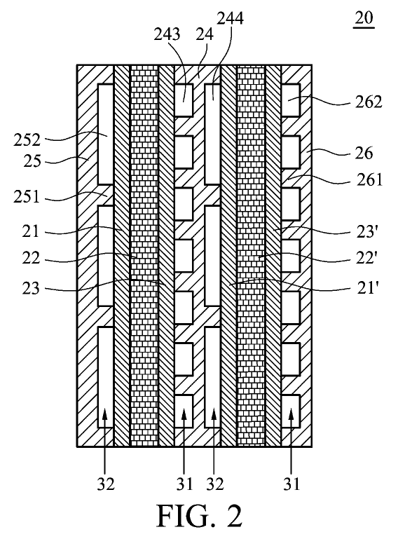

FIG. 2 is a cross section of a first embodiment of a fuel cell. The fuel cell of the first embodiment is a fuel cell module 20, including a cathode pressing board 25, a first cathode current collector 21, a first membrane electrode assembly (MEA) 22, a first anode current collector 23, an integrated cathode/anode flow board 24, a second cathode current collector 21′, a second membrane electrode assembly 22′, a second anode current collector 23′ and an anode pressing board 26 which are all stacked.

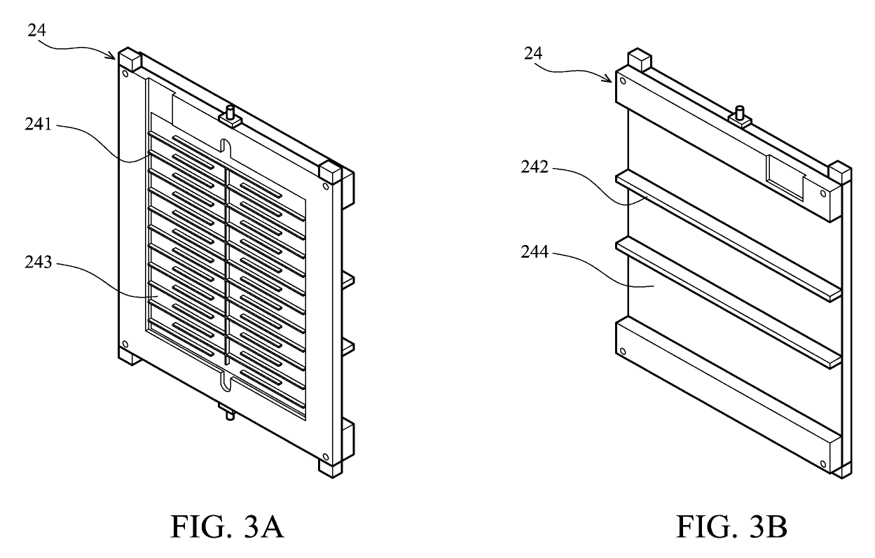

An anode surface and a catholic surface are two opposite surfaces of an integrated cathode/anode flow board 24. FIG. 3A shows the condition of the anode surface of the integrated cathode/anode flow board 24 of FIG. 2. A plurality of parallel ribs 241 are formed on the anode surface of the integrated cathode/anode flow board 24, and a plurality of first cathode channels 243 formed between the plurality of parallel ribs 241 are provided for fuel 31 to flow therethrough. FIG. 3B shows the condition of the cathode surface of the integrated cathode/anode flow board 24 of FIG. 2. A plurality of parallel ribs 242 are formed on the cathode surface of the integrated cathode/anode flow board 24, and a plurality of second cathode channels 244 formed between the plurality of parallel ribs 242 are provided for air 32 to flow therethrough.

The first and second membrane electrode assemblies 22 and 22′ are disposed on opposite sides of the integrated cathode/anode flow board 24, respectively.

The first cathode current collector 21 is abutted against one side of the first membrane electrode assembly 22, and the first anode current collector 23 is abutted against the other side of the first membrane electrode assembly 22. The first anode current collector 23 is also abutted against the anode surface of the integrated cathode/anode flow board 24, contacting the fuel 31 flowing through the plurality of first cathode channels 243.

The cathode pressing board 25 abutted against the first cathode current collector 21 comprises a plurality of ribs 251, and a plurality of second cathode channels 252 formed between the plurality of ribs 251 contact with the first cathode current collector 21 for the air 32 to flow therethrough.

The second cathode current collector 21′ is abutted against one side of the second membrane electrode assembly 22′, and the second anode current collector 23′ is abutted against the other side of the second membrane electrode assembly 22′. The second cathode current collector 21′ is also abutted against the cathode surface of the integrated cathode/anode flow board 24, contacting the air 32 flowing through the plurality of second cathode channels 244.

The anode pressing board 26 abutted against the second anode current collector 23′ comprises a plurality of ribs 261, and a plurality of second anode channels 262 formed between the plurality of ribs 261 contact with the second anode current collector 23′ for the fuel 31 to flow therethrough.

During operation of the fuel cell module 20, because the air 32 passing through the plurality of second cathode channels 244 of the integrated cathode/anode flow board 24 are located at the middle of the fuel cell module 20, efficient heat dissipation is achieved (with the air merely flowing through the outside thereof).

Additionally, due to the cathode pressing board 25 and the anode pressing board 26 being disposed outside of the fuel cell module 20, the cathode pressing board 25 and the anode pressing board 26 can effectively suppress and prevent the first cathode current collector 21 and the second anode current collector 23′ from protruding outwardly after long-term operation, thus, preventing increased impedance and decreased performance of the fuel cell module 20.

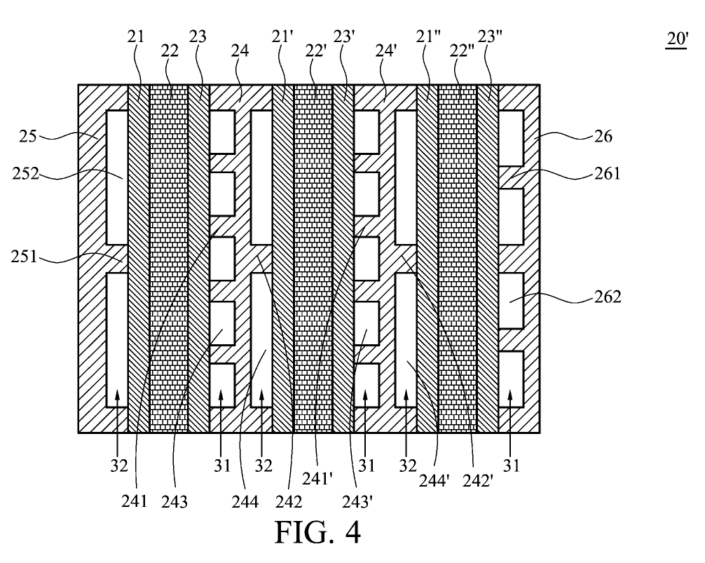

FIG. 4 is a cross section of a second embodiment of a fuel cell. In the second embodiment of the stacked fuel cell 20′, the same components as those of the first embodiment are denoted by the same reference numbers, and the same description for the same components are omitted herein for brevity. Compared to the fuel cell module 20 of the first embodiment, more membrane electrode assemblies 22″ and more integrated cathode/anode flow boards 24′ are stacked to increase output voltage thereof.

A plurality of parallel ribs 241′ are disposed on an anode surface of the integrated cathode/anode flow board 24′, and a plurality of second anode channels 243′ formed between the plurality of parallel ribs 241′ for the fuel 31 to flow therethrough. A plurality of parallel ribs 242′ are disposed on a cathode surface of the integrated cathode/anode flow board 24′, and a plurality of second cathode channels 244′ formed between the plurality of parallel ribs 242′ for the air 32 to flow therethrough.

The third cathode current collector 21″ is abutted against one side of the third membrane electrode assembly 22″, and the third anode current collector 23′ is abutted against the other side of the third membrane electrode assembly 22″. The third cathode current collector 21″ is also abutted against the cathode surface of the integrated cathode/anode flow board 24′, contacting the air 32 flowing through the plurality of first cathode channels 244′.

The anode pressing board 26 is abutted against a third anode current collector 23″, and the fuel 31 flows through the plurality of second anode channels 262.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell, comprising:
an integrated cathode/anode flow board, comprising a plurality of first cathode channels for air to flow therethrough and a plurality of first anode channels for a fuel to flow therethrough, wherein the first cathode channels and the first anode channels are disposed on opposite sides of the integrated cathode/anode flow board;
a first anode current collector contacting with the first anode channels;
a first cathode current collector;
a first membrane electrode assembly sandwiched between the first anode current collector and the first cathode current collector;
a second cathode current collector contacting with the first cathode channels;
a second anode current collector; and
a second membrane electrode assembly sandwiched between the second anode current collector and the second cathode current collector.

2. The fuel cell as claimed in claim 1 further comprising a cathode pressing board abutting against the first cathode current collector.

3. The fuel cell as claimed in claim 2, wherein the cathode pressing board comprises second cathode channels contacting with the first cathode current collector for the air to flow therethrough.

4. The fuel cell as claimed in claim 1 further comprising an anode pressing board abutting against the second anode current collector.

5. The fuel cell as claimed in claim 4, wherein the anode pressing board comprises second anode channels contacting with the second anode current collector for the fuel to flow therethrough.
